(19) United States
(12) Patent Application Publication
(10) Pub. No.: US 2014/0208211 A1
(43) Pub. Date: Jul. 24, 2014

(54) Allowing Web Meeting Attendees to Navigate Content During a Presentation

(71) Applicant: CISCO TECHNOLOGY, INC., San Jose, CA (US)

(72) Inventors: Zhonghui Luo, Danville, CA (US); Jitao Si, San Jose, CA (US); Ming Ming, Hefei City (CN); Wei Zhang, Hefei City (CN); Rui Zhao, Hefei City (CN); Changming He, Hefei City (CN)

(73) Assignee: Cisco Technology, Inc., San Jose, CA (US)

(21) Appl. No.: 13/746,428

(22) Filed: Jan. 22, 2013

(51) Int. Cl. G06F 3/0484

(52) U.S. Cl. CPC G06F 3/04847
USPC 715/730

(57) ABSTRACT

Techniques are presented to enable a meeting participant/attendee at an endpoint device in an online/web-based meeting/conference to navigate content of a presentation made by a presenter without disrupting the flow of the presentation made by the presenter. At the endpoint of a meeting attendee, data is stored representing content as it is being presented by a presenter at a presenter endpoint device. A command is received from an attendee at the attendee endpoint device to display previously presented content of the presentation. The attendee endpoint device retrieves data for the previously presented content from the stored data. During the presentation (but without disrupting the presenter's presentation of the content), the attendee endpoint device displays the previously presented content from the retrieved data.

### TECHNICAL FIELD

The present disclosure relates to on-line/web-based conference sessions or meetings.

### BACKGROUND

In on-line/web-based meetings in which one party is presenting materials to a plurality of meeting attendees, the attendees sometimes are viewing presentation materials of the presenter at slightly different paces. When this happens, some attendees may want to go back and view a previous presentation slide while the presenter moves to the next slide.

Currently, the presenter has complete control over the progress of the presentation materials and attendees cannot revert to previous slides of the presentation material. If an attendee wishes to view previously presented material, the attendee would have to interrupt the presenter and ask the presenter to go back to previous material, which could be disturbing since this would affect all of the attendees in the meeting.

### BRIEF DESCRIPTION OF THE DRAWINGS

FIG. 1 is a block diagram of an online/web-based conference system in which an attendee endpoint device is configured to allow an attendee to view previously presented content while a presentation is being made.

FIG. 2 is an example block diagram of the attendee endpoint device configured to allow an attendee to view previously presented content during the presentation.

FIG. 3 is a flow chart that generally depicts operations performed in the attendee endpoint device to allow an attendee to view previously presented content during the presentation.

FIG. 4 is a block diagram of an online/web-based conference system in which a paging signal sent by a presenter endpoint device is used by the attendee endpoint device to trigger a screenshot capture of a currently presented slide or page.

FIG. 5 is a block diagram of an online/web-based conference system in which a surge in an incoming data stream is used by the attendee endpoint device to trigger a screenshot capture of a currently presented slide or page.

FIG. 6 is a diagram that illustrates an example of how previously presented content and currently presented content may be displayed on an attendee endpoint device.

### DESCRIPTION OF EXAMPLE EMBODIMENTS

### Overview

Presented herein are techniques to enable a meeting participant/attendee at an endpoint device in an online/web-based meeting/conference to navigate content of a presentation made by a presenter without disrupting the flow of the presentation made by the presenter. At the endpoint of a meeting attendee, data is stored representing content as it is being presented by a presenter at a presenter endpoint device. A command is received from an attendee at the attendee endpoint device to display previously presented content of the presentation. The attendee endpoint device retrieves data for the previously presented content from the stored data. During the presentation (but without disrupting the presenter's presentation of the content), the attendee endpoint device displays the previously presented content from the retrieved data.

### Example Embodiments

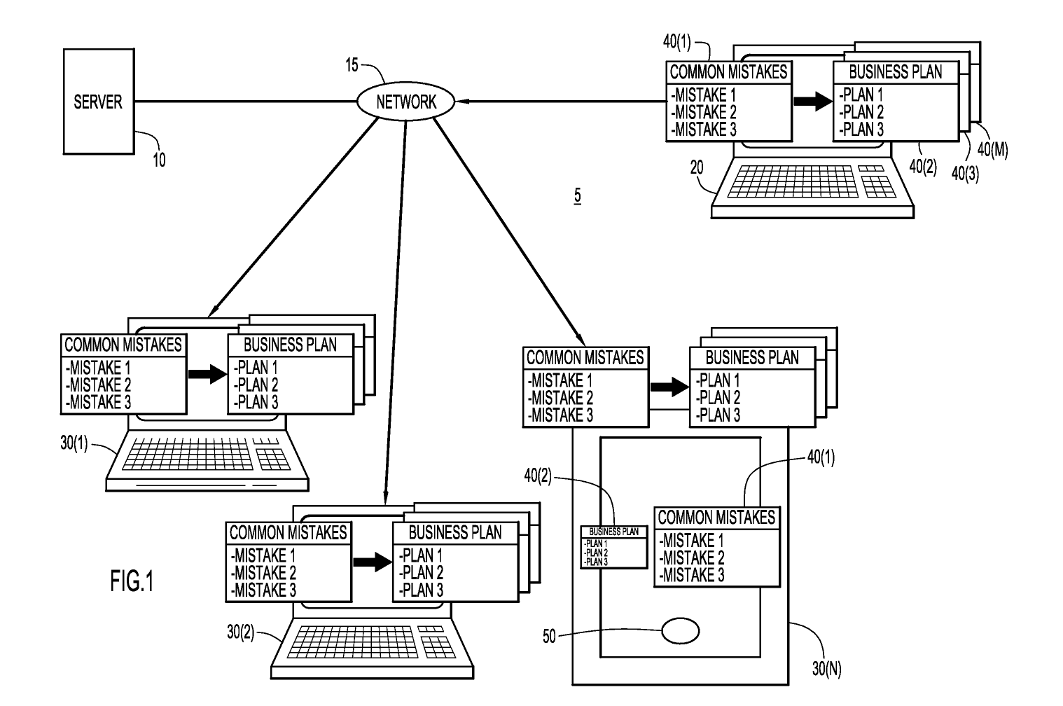

Referring first to FIG. 1, a web-based or online meeting/conference system 5 is shown. The system 5 includes a meeting server 10 and a plurality of endpoint devices that communicate with the meeting server 10 over network 15. The endpoint devices include a presenter endpoint device 20 and a plurality of attendee/participant endpoint devices 30(1)-30(N). The endpoint devices may take a variety of forms, including a desktop computer, laptop computer, mobile/cellular phone, tablet computer, etc. The network 15 may consist of one or more wired and/or wireless local and/or wide area networks. The endpoint devices are ubiquitous and while FIG. 1 shows that the presenter endpoint device 20 is a laptop computer, this is only by way of example. The presenter endpoint device 20 is an endpoint device from which a presentation is being made to meeting attendees at attendee endpoint devices 30(1)-30(N).

According to the techniques presented herein, an endpoint device that is used in an online/web-based meeting system is configured to allow any individual meeting attendee to “go back” and view previously presented content of a presentation, during the presentation, without affecting the presenter and the flow of the presentation made by the presenter. The presenter is completely unaware that an attendee is viewing previously presented material. All of the intelligence to enable the viewing of previously presented content of a presentation resides on an attendee's endpoint device.

The presentation content may take the form of presentation slides or pages of a document. The presentation slides may contain any content, such as text, images, animation, video, etc. The following description uses the term “slides” to refer to the presentation content, but this is not meant to be limiting. In FIG. 1, the presentation content that is being presented by a presenter is depicted by slides 40(1)-40(M). The presentation content is stored as it is being presented to allow a user at endpoint device to retrieve previously presented content during the presentation.

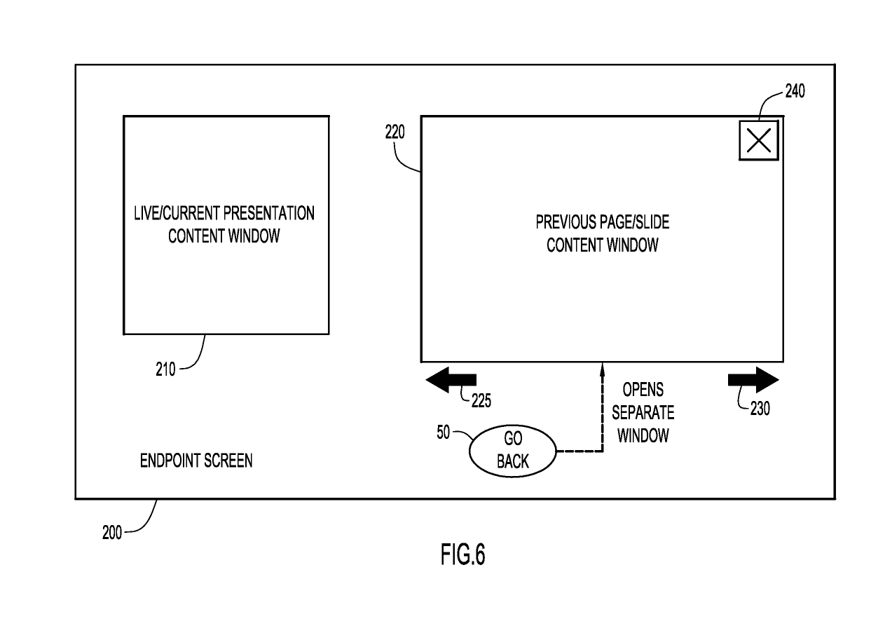

FIG. 1 shows that endpoint device 30(N) is configured/enabled to allow an attendee to go back and view previously presented content. A graphical user interface “Go Back” button 50 is displayed in the attendee endpoint device 30(N) presentation viewing interface (generated by meeting client software resident on the endpoint device 30(N)). Clicking the button 50 will allow the attendee at endpoint device 30(N) to see previously presented content during the presentation. For example, in the example of FIG. 1, the currently presented content is slide 40(2). However, when a user of endpoint device selects/clicks the “Go Back” button 50, the endpoint device 30(N) retrieves previously presented content, e.g., slide 40(1), for display while currently presented slide 40(2) is also being displayed. Moreover, any audio and/or video associated with the presenter sourced from the presenter's endpoint device 20 is still being played in real-time with the presentation on endpoint device 30(N) (as it would be on endpoint devices 30(1) and 30(2)). FIG. 1 shows that the window in which the previously presented slide 40(1) is displayed is larger than the window in which the currently presented slide 40(2) is displayed. Further examples of display formats that may be used on an endpoint device 30(1)-30(N) are described further hereinafter in connection with FIG. 6. Any of the endpoint devices 30(1), 30(2), etc., shown in FIG. 1 can be configured in a similar manner as endpoint device 30(N), but for simplicity only endpoint device 30(N) is shown to be so configured.

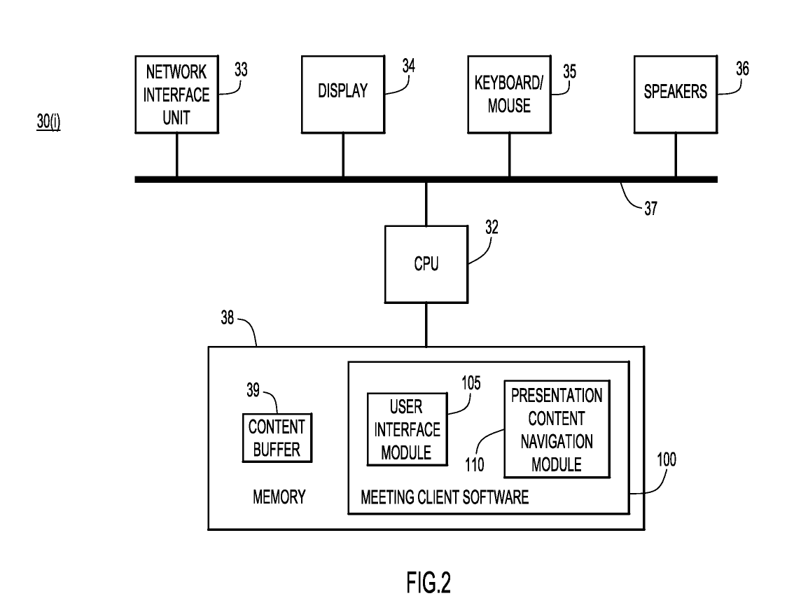

Turning now to FIG. 2, an example block diagram is shown of an endpoint device that is configured to view previously presented content during a presentation. The endpoint device shown in FIG. 2 is identified generically by reference numeral 30(i) to indicate that any of the endpoint devices 30(1)-30(N) may be configured as shown in FIG. 2. The endpoint device 30(i) includes a central processing unit (CPU) 32, network interface unit 33, display unit 34, keyboard/mouse 35, and audio speakers 36, each of which is connected to a bus 37. The network interface unit 33 is a network interface card (NIC), for example, that enables network communications on behalf of the endpoint device 30(i).

A memory 38 is provided that stores data received and generated in the course of operation of the endpoint device 30(i). The memory 38 includes allocated space for a content buffer 39 used to cache/buffer previously presented content (e.g., screenshot data) captured during a presentation for retrieval and display at the endpoint, upon trigger of a command by an attendee/user of the endpoint device during a presentation. The memory 38 also stores or is encoded with software, for execution by the CPU 32, for performing the operations of the endpoint 30(i). To this end, the memory 38 stores meeting client software 100. The meeting client software 100 enables the endpoint device 30(i) to participate in an online/web-based meeting. The meeting client software 100 includes a user interface module 105 and a presentation content navigation module 110. The user interface module 105 handles the presentation of content at the endpoint, including both graphical user interface elements, visually display of content (still images and video images) on display 34, and output of audio on speakers 36. The user interface module 105 is, for example, responsible for generating and displaying the “Go Back” button 50 (FIG. 1) and detecting when a user selects/clicks the button 50. The presentation content navigation module 110 is responsible for handling the operations at the endpoint device to store data (e.g., screenshot data) associated with content of a presentation as it is being displayed, respond to activation of the “Go Back” button 50, retrieve data for previously presented content and display the previously presented content.

Memory 38 may comprise read only memory (ROM), random access memory (RAM), magnetic disk storage media devices, optical storage media devices, flash memory devices, electrical, optical, or other physical/tangible memory storage devices. The CPU 32 is, for example, a microprocessor or microcontroller that executes instructions for the meeting client software 100. Thus, in general, the memory 38 may comprise one or more tangible (non-transitory) computer readable storage media (e.g., a memory device) encoded with software comprising computer executable instructions and when the software is executed (by the processor CPU 38) it is operable to perform the operations described herein for the meeting client software 100.

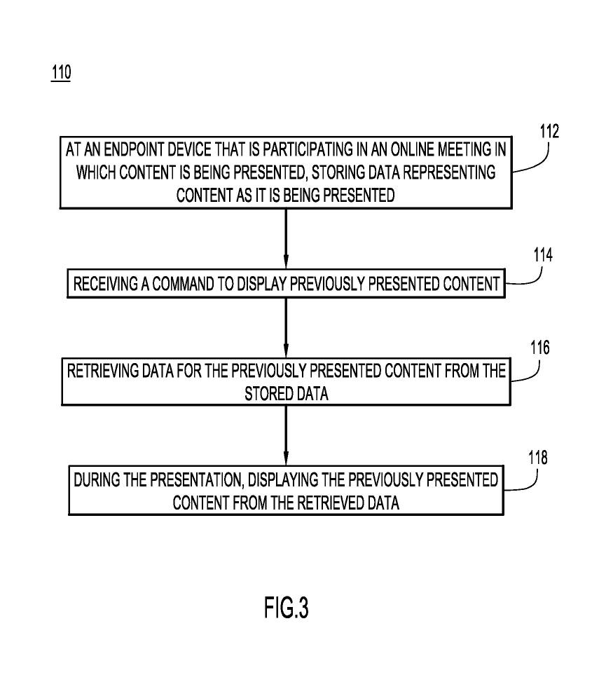

Turning now to FIG. 3, a flow chart is shown that depicts examples of operations performed by an endpoint device to display previously presented content during a presentation. The operations shown in FIG. 3 may be performed when the CPU 32 executes the software instructions for the presentation content navigation module 110 at an endpoint device that is participating in an online meeting in which content is being presented. At 112, data representing the content is stored/cached as the content is being presented. At 114, a command is received (from an attendee using that endpoint device) to display previously presented content. For example, the command is generated when an attendee/user clicks a “Go Back” button on his/her endpoint device. At 116, data is retrieved from the stored data for the previously presented content, in response to receiving the command. At 118, during the presentation, the previously presented content (obtained from the retrieved data) is displayed on the display of the endpoint device. Thus, operation 118 involves displaying the previously presented content while the presentation is ongoing and without interrupting/disrupting the presenter and other meeting attendees. The presenter is completely unaware that an attendee may be viewing previously presented content during his/her presentation.

The content being presented may comprise a plurality of slides of a presentation or pages of a document. In this case, the storing operation 112 involves storing data representing the slides or pages as they are being presented, the receiving operation 114 involves receiving a command to display a previously presented slide or page, the retrieving 116 operation involves retrieving data for the previously presented slide or page from the stored data, and the displaying operation 118 involves displaying the previously presented slide or page from the retrieved data during the presentation.

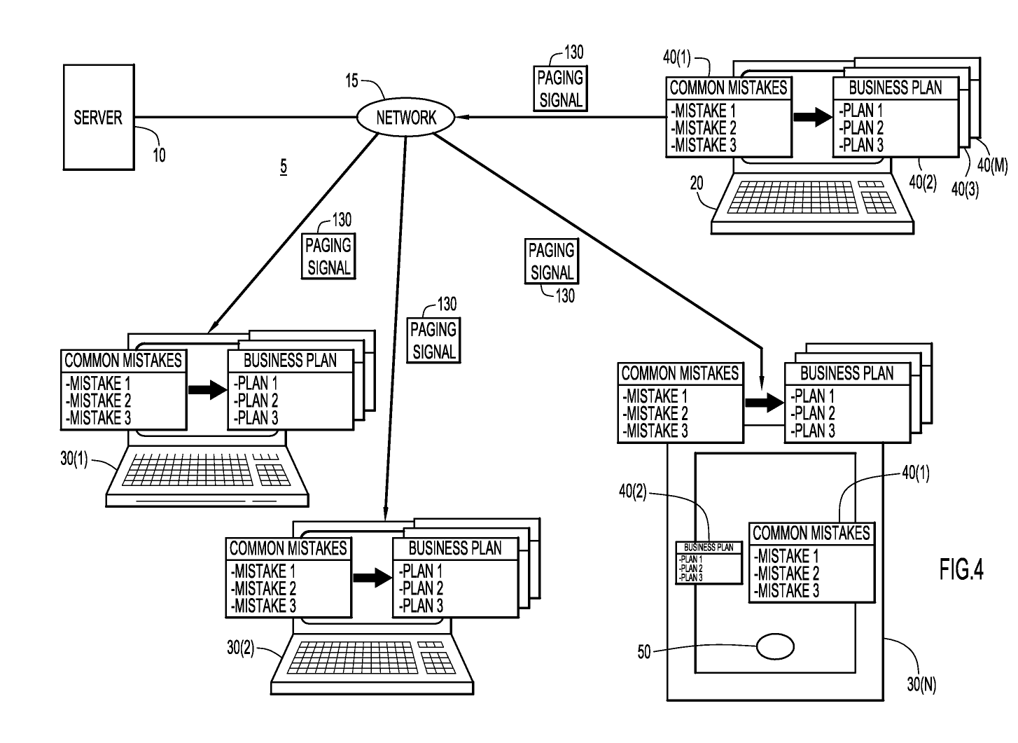

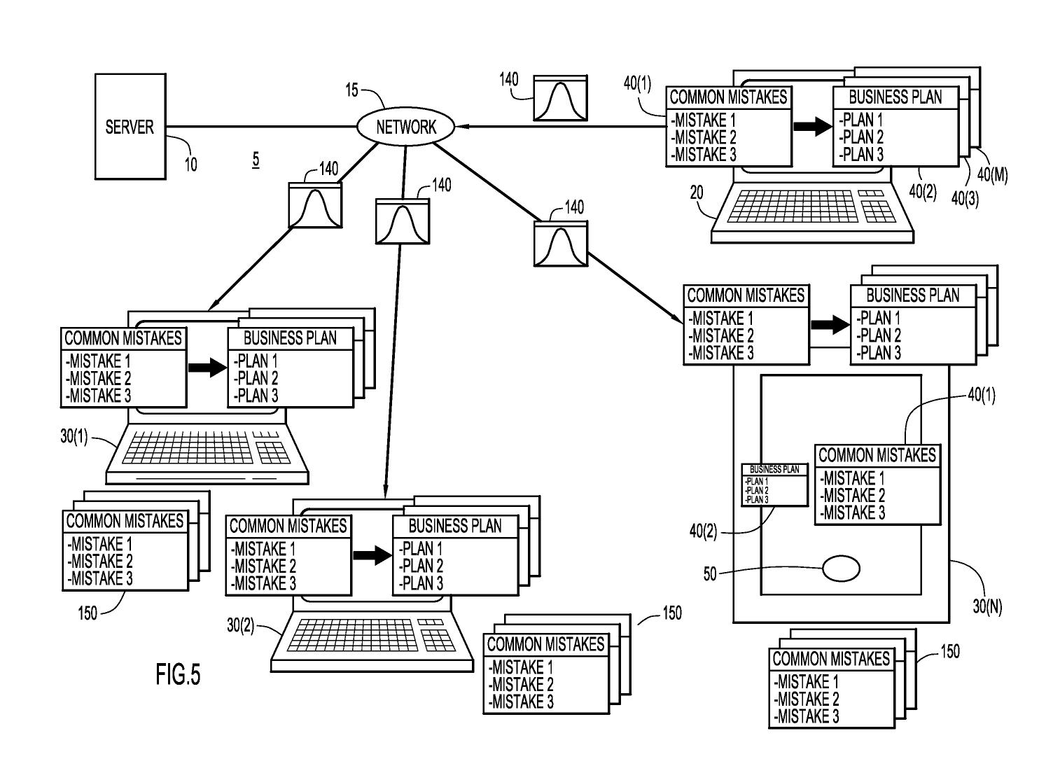

There are several ways that an endpoint device may store data for content as it is being presented to allow it to be retrieved during a meeting. According to one method, the meeting client software on the endpoint device detects each slide or page change, and takes a screenshot of the displayed content of the currently displayed slide or page for each detected change, and before the slide/page that is being displayed at the attendee endpoint device is changed. The meeting client software may save/buffer a predetermined number of the most recent screenshots, e.g., 10 screenshots, corresponding to the most recent 10 slides/pages. When a user clicks the “Go Back” button, the endpoint will display the screenshots for the previously presented content. FIGS. 4 and 5 illustrate variations to detect, at an attendee endpoint device, when a presenter is changing/moving between pages/slides of a presentation.

Referring now to FIG. 4, a configuration of system 5 is shown in which a paging signal, generated by presenter endpoint device 20, is used to trigger the screenshot capture at an attendee endpoint device. As shown in FIG. 4, in this system configuration, a presenter has invoked a feature in which the presenter endpoint device 20 shares a data file for the presentation (slides or pages of a document). This feature is known as “Document Sharing”. When this feature is invoked, the presenter endpoint device 20 uploads a copy of its presentation content file to the meeting server 10. Each endpoint device 30(1)-30(N) participating in the meeting with presenter endpoint device 20 pre-fetches from the meeting server 10 the presentation content file for the meeting presentation being made by the presenter at endpoint device 20. Thus, each attendee endpoint device has a duplicate copy of the presentation content file that the presenter is using at the presenter endpoint device 20. The presenter endpoint device 20 sends a “paging” signal 130 to the meeting server 10 each time the presenter changes slides or pages of a presentation, e.g., moves from slide/page 40(1) to 40(2). The meeting server 10 forwards the paging signal 130 to each of the attendee endpoint devices 30(1)-30(N) to notify the attendee endpoints to move to next slide/page. The receipt of a paging signal 130 from the meeting server 10 alerts each attendee endpoint device to move/change to the next slide or page of the presentation content file that is locally stored at each attendee endpoint device. Thus, in “Document Sharing” each endpoint initially receives the entire document file that is being shared for a presentation. A paging signal 130 from the meeting server (sent by the presenter endpoint device) triggers each endpoint to page through the document as the presenter at the presenter endpoint device is paging through the document.

Once paging signal 130 is received at an endpoint configured as depicted in FIG. 2, the meeting client software will take a new screenshot of the displayed content to cache a copy of that screen (containing a currently presented page/slide) before a new screen is displayed (containing the next page/slide to be presented). Thus, the paging signal indicates a change to the next slide or page by a presenter, and the detection of a page/slide change is based on receipt of paging signal 130. The paging signal 130 is detected at an endpoint device and used to trigger capturing of a screenshot of a current presentation page/slide before changing to display the next page/slide. The attendee endpoint device can store a predetermined number of the most recent (last) screenshots, e.g., 10, so that the attendee can go back as many as 10 pages/slides. Since the presentation slides/pages (both currently presented and previously presented) are already locally stored at the attendee endpoint devices, the meeting client software in the attendee endpoint device can store an indication of the slide/page number for the currently presented slide/page. When a meeting attendee wants to go back to view a previously presented slide/page, the meeting client software retrieves the data to go back page by page from the currently presented page.

Turning now to FIG. 5, another way to detect page/slide changing at an attendee endpoint device is now described. FIG. 5 shows a configuration of system 5 in which an application or “desktop” of the presenter endpoint device 20 is shared during a meeting with the attendee endpoint devices 30(1)-30(N) to enable the presenter to share pages/slides of a presentation. In this configuration, screenshot data captured from the presenter endpoint device 20 are pushed down to the attendee endpoint devices 30(1)-30(N). New screenshot data is uploaded from the presenter endpoint device 20 when the presenter moves to the next page/slide, and the meeting server pushes the new screenshot data to attendee endpoint devices 30(1)-30(N). An increase or surge, shown at reference numeral 140, in the incoming data stream to each attendee endpoint device will occur when new screenshot data caused by slide/page changing by the presenter at presenter endpoint device 20 is being sent. Thus, the attendee endpoint device can monitor for changes in the incoming presentation data stream. An increase or surge that meets a predefined threshold is indicative of a change to the next slide or page by the presenter. When the attendee endpoint device detects a change (increase or surge) that meets the predefined threshold, the attendee endpoint interprets the increase or surge in the incoming data stream as a change to the next slide/page, and a new screenshot is taken at that time (before the new screenshot data for the next slide arrives and is displayed) at the attendee endpoint device in order to save that slide/page for possible later viewing by the attendee. FIG. 5 shows a plurality of screenshots 150 saved at the attendee endpoint devices 30(1)-30(N). As explained above, a predetermined number of screenshots, e.g., 10, can be saved to allow a user/attendee to go back and view up to 10 slides/pages, whenever the attendee/user desires.

To summarize, FIGS. 4 and 5 illustrate examples of two different ways to detect, at an attendee endpoint device, a change from a currently presented slide or page to a next slide or page during a presentation. As changes are made by a presenter from a current presented slide or page to a next slide or page, a storing operation is performed to capture a screenshot of the currently presented slide or page in response to detecting the change and before display of the next slide or page. This allows an attendee to subsequently retrieve a stored screenshot that contains the previously presented slide or page. The attendee endpoint device may store a predetermined number of screenshots for a corresponding predetermined number of slides or pages that are to be available to an attendee to “go back” and view. The previously presented slide or page that is displayed to an attendee at an attendee endpoint device during the presentation involves a display of screenshot data, without any audio (e.g., of the presenter) that may have occurred during the presentation in association with that previously presented slide or page.

Still another method to allow for an attendee to review previously presented content of a presentation is to capture screenshots at the attendee endpoint device at a predetermined frequency (period). For example, meeting client software is configured to capture a screenshot of the displayed screen content on the attendee endpoint device every 3 seconds, for example, and save the most recent 5 screenshots. A timer function of the meeting client software may be used to trigger a screenshot capture at a predetermined frequency and save it. A presenter usually stays on a slide/page for at least one minute. When an attendee wants to go back to previous content (a previous slide or page), the meeting client software will go back a number of cached screen shots estimated to the amount of time necessary to retrieve stored screenshot data to get to the previous slide/page. To summarize this method, the attendee endpoint device periodically captures a screenshot of content being displayed at the endpoint device and saves a predetermined number of screenshots. The endpoint device can then subsequently retrieve one of the saved screenshots estimated to contain content for a previously presented slide or page in response to a user selecting the “Go Back” button.

Yet another method is to record attendee endpoint device screen content as a video clip and save the last few minutes of screen content recorded locally at the attendee endpoint device. The “Go Back” button will replay the video clip at the attendee endpoint device. A pause button may be provided to allow a user to pause on a particular portion of the video clip corresponding to a particular slide/page of a presentation. Thus, the attendee endpoint device would continuously record video, but the video is immediately accessible to a user at that endpoint device. The recording may be screen content only, not audio of a person speaking during the presentation. As a result, there is no need to synchronize audio of a person speaking (the presenter) with the video content. The continuously recorded video is written over such that there is always a video clip of a predetermined period of time available on the attendee endpoint device. Unlike conventional server-based recording techniques, this recording is local to a particular attendee endpoint device, and is immediately available for playback during a meeting in which more current content is being presented. In some configurations, the recording may include audio, but some time lag may be incurred for playback to allow for processing of the audio and video portions to synchronize them prior to being available for playback. In summary, according to this method, video of content being displayed at the attendee endpoint device is recorded, and data representing the recorded video is saved for a predetermined period of time on a continuous loop basis. The attendee endpoint device may replay recorded video estimated to contain the previously presented slide or page in response to a user selecting the “Go Back” button.

The techniques described above may be used for any type of presentation content, including animation and video content. For the technique described above in connection with FIG. 5, a threshold may be set for screen content changes to account for animated/video content.

Reference is now made to FIG. 6. FIG. 6 illustrates an example of a screen layout useful on an attendee endpoint device to display previous presentation content and current presentation content. A display screen 200 includes a window 210 for currently presented presentation content and a window 220 for previously presented content, and the “Go Back” button 50. Normally, window 210 containing the current presentation content is sized to take up nearly the entire display screen 200. When a user clicks on the button 50, the window 220 is opened and window 210 is reduced in size and moved to a portion of the screen 210, so that window 220 is larger than window 210. Once window 220 is opened, reverse button 225 and forward button 230 are displayed. Initially, when the “Go Back” button is clicked, the immediately previous slide/page is displayed in window 220. The user can click reverse button 225 to step back to still previous slides/pages of the presentation in window 220, stay on a particular slide/page for as long as he/she desires, and then move forward through the slides/pages by clicking forward button 230. While the user is scrolling through previously presented content in window 220, the currently presented content is being displayed in window 210, and real-time audio associated with the currently presented content (e.g., the presenter's audio) is being played out to the user of the attendee endpoint device. When a user wishes to terminate the display of the previously presented content, he/she may click the “X” graphical element 240 in window 220 to close window 220. When this occurs, the meeting client software on the endpoint device will return window 210 to its normal “full” dimensions on screen 200. Thus, to summarize, FIG. 6 illustrates an example display screen layout in which a previously presented slide or page and a currently presented slide or page are simultaneously displayed. Commands may be received from a user of the attendee device to navigate forward or backward among a plurality of previously presented slides or pages.

Conventional meeting recording involves a consolidation of data from the meeting (audio and video) and is available from a recording server only some period of time after the meeting ends. This does not allow a meeting attendee to, during the meeting, go back to review materials previously presented in the meeting. The techniques presented herein involve capturing at a meeting endpoint device screenshots of individual slides or pages of presentation content, and allowing a user at that meeting endpoint to selectively go back and view one or more previously presented slides or pages of presentation content during the online meeting in which the presentation material is being presented. Meeting attendees can individually go back to previous presentation content without affecting the presenter and other attendees. For example, a first meeting attendee may wish to view the immediately previous slide or page of a presentation at some point in time, while a second meeting attendee may wish to view a slide or page three prior slides/pages previous to the currently presented slide/page. Each meeting attendee can independently select which previously presented content they wish to view without affecting any of the other meeting attendees.

These techniques can be very helpful to meeting attendees to understand the presented subject matter without affecting the presenter and/or other meeting attendees. This review feature is unique to a web-based/online meeting because each meeting attendee endpoint device is independent of the presenter's endpoint device and of the other meeting attendee endpoint devices. When these techniques are used, web-based/online meetings can be a better learning/presentation tool than in-person meetings.

The above description is intended by way of example only.

What is claimed is:

1. A method comprising:
at an endpoint device that is participating in an online meeting in which content is being presented as part of a presentation, storing data representing the content as it is being presented;
receiving a command to display previously presented content;
retrieving data for the previously presented content from the stored data; and
during the presentation, displaying the previously presented content from the retrieved data.

2. The method of claim 1, wherein the content being presented comprises a plurality of slides of a presentation or pages of a document, and storing comprises storing data representing the slides or pages as they are being presented, receiving a command comprises receiving a command to display a previously presented slide or page, retrieving comprises retrieving data for the previously presented slide or page from the stored data, and displaying comprises displaying the previously presented slide or page from the retrieved data during the presentation.

3. The method of claim 2, further comprising detecting a change from a currently presented slide or page to a next slide or page, wherein storing comprises capturing a screenshot of the currently presented slide or page in response to the detecting and before display of the next slide or page, and wherein retrieving comprises retrieving a stored screenshot that contains the previously presented slide or page.

4. The method of claim 3, wherein storing comprises storing a predetermined number of screenshots for a corresponding predetermined number of slides or pages.

5. The method of claim 3, wherein detecting comprises detecting a paging signal sent from a meeting server, the paging signal indicating a change to the next slide or page by a presenter.

6. The method of claim 3, wherein detecting comprises detecting an increase in an incoming data stream received from a meeting server, the increase being indicative of a change to the next slide or page by a presenter.

7. The method of claim 2, wherein storing comprises periodically capturing a screenshot of content being displayed at the endpoint device and saving a predetermined number of screenshots, and wherein retrieving comprises one of the saved screenshots estimated to contain content for a previously presented slide or page.

8. The method of claim 2, wherein storing comprises recording video of content being displayed at the endpoint device and saving data representing recorded video for a predetermined period of time, wherein retrieving comprises replaying recorded video estimated to contain the previously presented slide or page.

9. The method of claim 2, wherein displaying comprises displaying on a screen the previously presented slide or page and a currently presented slide or page.

10. The method of claim 2, further comprising receiving a command to navigate forward or backward among a plurality of previously presented slides or pages.

11. The method of claim 1, wherein receiving the command comprises detecting selection by a user of a graphical user interface button on a screen displayed at the endpoint device.

12. One or more computer readable storage media encoded with software comprising computer executable instructions and when the software is executed operable to:
at an endpoint device that is participating in an online meeting in which content is being presented as part of a presentation, store data representing the content as it is being presented;
receive a command to display previously presented content;
retrieve data for the previously presented content from the stored data; and
during the presentation, display the previously presented content from the retrieved data.

13. The computer readable storage media of claim 12, wherein the content being presented comprises a plurality of slides of a presentation or pages of a document, further comprising instructions operable to detect a change from a currently presented slide or page to a next slide or page, wherein the instructions operable to store comprise instructions operable to capture a screenshot of the currently presented slide or page in response to detecting a change from a currently presented slide or page to a next slide or page and before display of the next slide or page, and wherein the instructions operable to retrieve comprise instructions operable to retrieve a stored screenshot that contains the previously presented slide or page.

14. The computer readable storage media of claim 13, wherein the instructions operable to detect comprise instructions operable to detect a paging signal sent from a meeting server, the paging signal indicating a change to the next slide or page by a presenter.

15. The computer readable storage media of claim 13, wherein the instructions operable to detect comprise instructions operable to detect an increase in an incoming data stream received from a meeting server, the increase being indicative of a change to the next slide or page by a presenter.

16. The computer readable storage media of claim 13, wherein the instructions operable to display on a screen the previously presented slide or page and a currently presented slide or page.

17. An apparatus comprising:
a network interface unit configured to enable communications over a network enable an endpoint device to participate in an online meeting in which content is being presented as part of a presentation;
a display unit;
a memory;
a processor coupled to the network interface device, the memory and the display, wherein the processor is configured to:
store data representing the content as it is being presented;
receive a command to display previously presented content;
retrieve data for the previously presented content from the stored data; and
during the presentation, display on the display unit the previously presented content from the retrieved data.

18. The apparatus of claim 17, wherein the content being presented comprises a plurality of slides of a presentation or pages of a document, wherein the processor is further configured to detect a change from a currently presented slide or page to a next slide or page, and to capture a screenshot of the currently presented slide or page in response to detecting a change from a currently presented slide or page to a next slide or page and before display of the next slide or page, and to retrieve comprise instructions operable to retrieve a stored screenshot that contains the previously presented slide or page.

19. The apparatus of claim 18, wherein the processor is configured to detect the change by detecting a paging signal sent from a meeting server, the paging signal indicating a change to the next slide or page by a presenter.

20. The apparatus of claim 18, wherein the processor is configured to detect the change by detecting an increase in an incoming data stream received from a meeting server, the increase being indicative of a change to the next slide or page by a presenter.

21. The apparatus of claim 18, wherein the processor is configured to display on a screen the previously presented slide or page and a currently presented slide or page.
